(19) United States
(12) Patent Application Publication
(10) Pub. No.: US 2010/0107086 A1
(43) Pub. Date: Apr. 29, 2010

(54) METHOD AND SYSTEM FOR GENERATING REPORT CONDITION INPUT INTERFACE

(75) Inventors: Yu Chen, Shenzhen (CN); Xinyu Zhou, Shenzhen (CN); Anuradhac, Bangalore (IN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/649,579

(22) Filed: Dec. 30, 2009

Related U.S. Application Data
(63) Continuation of application No. PCT/CN2008/071387, filed on Jul. 20, 2008.

(30) Foreign Application Priority Data
Jul. 2, 2007 (CN) 200710123224.1

(51) Int. Cl. G06F 3/01

(52) U.S. Cl. 715/745

(57) ABSTRACT

A method and system for generating a report condition input interface are provided. In an embodiment, the method includes: inquiring a corresponding relation list according to the condition data type entered by a user, to obtain at least one graphical control corresponding to the condition data type; assembling at least one determined graphical control to generate a condition input interface.

### CROSS-REFERENCE TO RELATED APPLICATIONS

This application is a continuation of International Application No. PCT/CN2008/071387, filed on Jun. 20, 2008, which claims priority to Chinese Patent Application No. 200710123224.1, filed on Jul. 2, 2007, both of which are hereby incorporated by reference in their entireties.

### FIELD OF THE TECHNOLOGY

The present invention relates to the field of graphical interface technologies, and more particularly, to a method and system for generating a report condition input interface.

### BACKGROUND OF THE INVENTION

A conventional report generation system is as shown in FIG. 1. The report generation system includes a condition input module 101, a report generation module 102, a data source module 103, and a report output module 104.

The data source module 103 stores various data required for generating a report. The report generation module 102 includes a report template pre-defined by a user. The report template refers to a pre-defined file having a data source, a data source condition, a user condition, a report layout, and other information, and the report template may pre-determine a structure and a style of the generated report. The condition input module 101 is configured to receive condition data entered by the user. According to the condition data, the report generation module 102 invokes the corresponding report template, inquires the required data from the data source module 103, and fills the inquired data into the report template, so as to obtain the required report. The report is output through the report output module 104.

About the condition input module 101, the conventional report generation system mostly adopts the following solution. A multi-line input box is provided, and relevant contents are entered into the input box, in which the relevant content may be names or numerical values. The report generation module 102 analyses the contents and obtains the relevant condition data. FIG. 2 shows an example of an input interface provided by the conventional condition input module 101.

In the example, it is required to output a report of personal information of all the male employees aged between 25 and 30. The input conditions include gender=male and age=25-30.

The report condition input interface similar to that of FIG. 2 has a single form and lacks flexibility. Similarly, the finally generated report interface lacks the flexibility. Therefore, the following defects exist.

The user should understand the contents and the format of the data stored in the data source module 103, for example, the provided gender data is [symbol] instead of “male”. Therefore, the user should be trained, so as to master the use of the report generation system, which has a low feasibility.

In addition, once being determined, the condition input interface cannot be altered. During a practical operation, the user intends to perform various combinations on the different reports according to different forms of condition input controls, for example, a combo box is selected and then the list is selected, or the list is selected and then the combo box is selected. The combinations may be varied, and the conventional condition input module cannot exemplify all the combination manners one by one.

### SUMMARY OF THE INVENTION

In an embodiment, the present invention provides a generation method for a report condition input interface, which is capable of providing various controls for being selected by a user, thereby generating a corresponding condition input interface according to a need of the user.

The method includes the following steps.

A corresponding relationship list between condition data types and graphical controls is inquired according to a condition data type entered by the user, and at least one graphical control corresponding to the condition data type is determined.

The at least one determined graphical control is assembled, so as to generate the condition input interface.

In an embodiment, the present invention also provides a generation apparatus for a report condition input interface, which includes an inquiry unit and an interface assembly unit.

The inquiry unit is configured to inquire a set-up corresponding relationship between condition data types and graphical controls according to a condition data type entered by a user, so as to acquire at least one graphical control corresponding to the condition data type.

The interface assembly unit is configured to assemble the graphical controls inquired by the inquiry unit and generate a condition input interface.

It can be known from the technical solution that in the embodiments of the present invention, the corresponding relationship between the condition data types and the graphical controls is set, so that for the condition data provided by the user, various complex controls may be provided for being used by the user, thereby improving a usability of a report generation system, and satisfying a need of the user of the report on a complex input condition.

### BRIEF DESCRIPTION OF THE DRAWINGS

FIG. 1 is a schematic structural view of a report generation system in the prior art;

FIG. 2 is a view of an example of a report condition input interface in the prior art;

FIG. 3 is a flow chart of generating a report interface according to an embodiment of the present invention;

FIG. 4 is a schematic view of a principle according to an embodiment of the present invention; and

FIG. 5 is a schematic structural view of an input interface generation module according to an embodiment of the present invention.

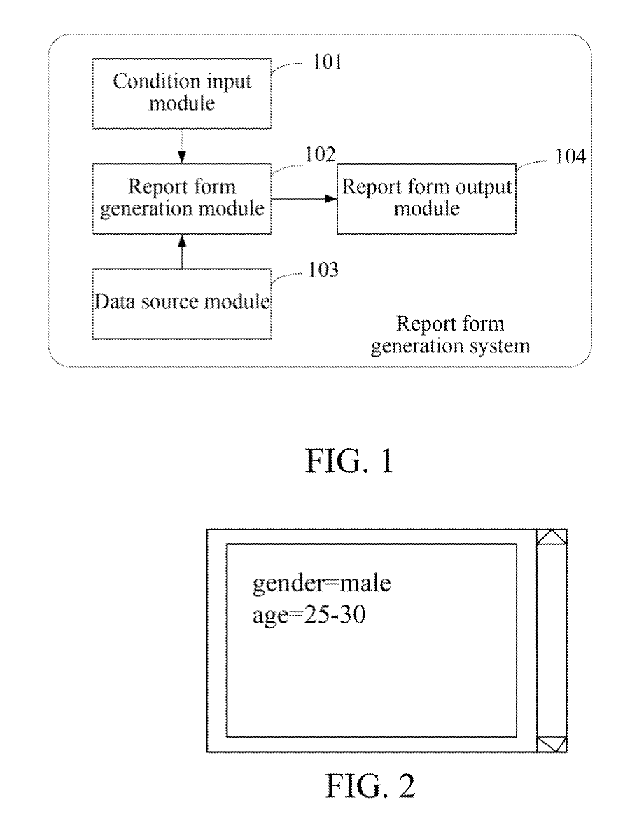

### DETAILED DESCRIPTION OF THE EMBODIMENTS

In an embodiment of the present invention, a corresponding relationship between condition data and graphical controls is set. The condition data is condition information entered by a user and configured to generate a report, for example, the gender condition and the age condition exemplified in the prior art. The graphical controls are configured to form graphics for representing the condition data and displayed to the user through graphical interfaces, for example, a text input box, a list box, or a combo box, so as to display the data in a model module. Therefore, the graphics and the data are separated. The condition data may be obtained from an inquiry result of a database of a data source module in a report generation system, or may be pre-set, in which the condition data is manually entered by the user or is selected from possible permissible values. The representation of the condition permissible values may be controlled by the graphical controls. Therefore, the user may self-define the corresponding relationship between the permissible values of the condition data and the graphical controls. In an embodiment of the present invention, each condition data and the corresponding graphical control are saved in a file named Conditions.xml.

One condition data may correspond to at least one graphical control. Different graphical controls decide the display situations in the condition input interfaces, so that by selecting the graphical controls, various forms of condition input interfaces may be flexibly generated.

In addition, the generation of the report may need control information of non-condition data, for example, information controlling front and color of the report, and other display appearance control information, or information displayed in the report and irrelevant to the condition data, for example, a tabulator, a tabulating time, and other information.

In order to enable the user to enter or select the report control information of the non-condition data through the condition input interface, some graphical controls configured to enter or select the report control information of the non-condition data are further provided.

In order to make objectives, technical solutions, and advantages of the present invention more comprehensible, a detailed description of the present invention is given below by reference to accompanying drawings.

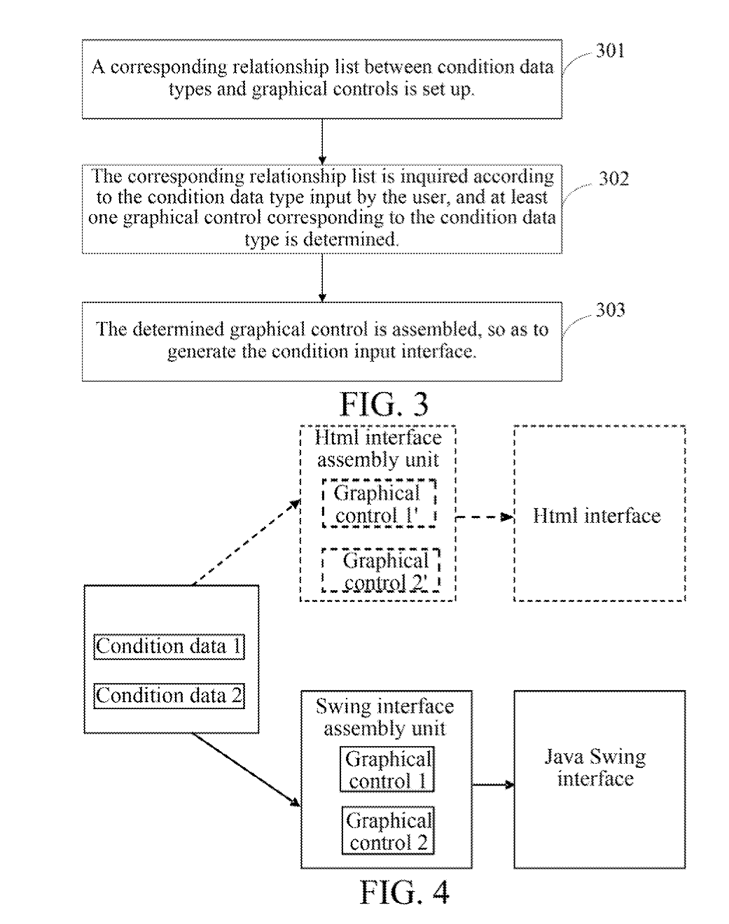

Referring to FIG. 3, the process of generating a report interface according to an embodiment of the present invention is shown, which includes the following steps.

In step 301, a corresponding relationship list between condition data types and graphical controls is set. The different condition data types correspond to the different graphical controls, and the same group of the condition data types may also correspond to various graphical controls. For example, a single-line data type may correspond to a radio button or a single-line text box, in which the radio button may be a list box, a combo box, and other forms. The radio button or the single-line text box corresponds to condition data entered by a user. The multi-line data type may correspond to a check box or a multi-line text box, and the multi-group data may correspond to a tree structure. Table 1 shows the corresponding relationship list between the condition data types and the graphical controls according to an embodiment of the present invention, but the form and the contents of the corresponding relationship list are not limited here.

TABLE 1

| Condition Data Type | Graphical Control |
|---|---|
| String | DateTimeChooser |
| | ComboBox |
| | ListBox |
| | TextArea |
| | TextBox |
| Integer | ComboBox |
| | ListBox |
| | NumberTextField |
| | SpinEditor |
| Long | ComboBox |
| | ListBox |
| | NumberTextField |
| | SpinEditor |
| Boolean | Boolean |
| Byte | ComboBox |
| | ListBox |
| | NumberTextField |
| | SpinEditor |
| Float | ComboBox |
| | ListBox |
| | NumberTextField |
| Double | ComboBox |
| | ListBox |
| | NumberTextField |
| Date | DateTimeChooser |
| | ComboBox |
| | ListBox |
| Other | SortBuilder |
| | ComboBox |
| | ListBox |
| | IPAdressField |
| | ColorChooser |
| | WhereBuilder |
| | DoubleList |
| | TextBox |

In step 302, the corresponding relationship list is inquired according to the condition data type entered by the user, and at least one graphical control corresponding to the condition data type is determined.

The report generation system may automatically and reasonably arrange the graphics according to a size of each graphical control, so as to arrange the representation form of the condition data according to a certain rule, and select the graphical control corresponding to the condition data, thereby improving the operability when the user uses the report.

In step 303, the at least one determined graphical control is assembled, so as to generate the condition input interface. The process includes the following steps.

In step 303a, each selected graphical control is analyzed, and according to the attribute of each graphical control, it is determined whether the graphical controls need to be assigned on one window or a plurality of label pages of one window. For the situation of assigning the graphical controls on one window, the number of the label pages of the window is 1. The step further includes displaying the graphical control configured to display the report control information of the non-condition data on the window or the label pages of the window. The report control information of the non-condition data may be information controlling front and color of the report, and other display appearance control information, or information displayed in the report and irrelevant to the condition data, for example, a tabulator, a tabulating time, and other information.

In step 303b, a display effect of each display window or the label page of the window is determined. The display size and the display position of each graphical control are determined. A maximum width and a maximum height are analyzed for all the graphical controls on the same window, so as to determine the size of the window. Further, the system may reserve a margin according to a pre-configured ratio or a ratio set by the user, thereby achieving an optimal visual effect.

In step 303c, for each graphical control with the determined display effect, a corresponding result value is inquired from the database according to the condition data entered by the user, and the inquired result value is filled into the graphical control for being selected and/or filled by the user.

In step 303d, according to the content selected and/or filled by the user, the display effect of the current condition input interface is displayed to the user. Further, the display effect of the condition input interface may be adjusted according to an adjusting instruction from the user, in which a size, a position, and a sequence of the display graph of each condition component are adjusted. The step is optional.

In step 303e, according to acknowledge information of the previewed condition input interface from the user, a formal condition input interface is generated, and the condition input interface is displayed to the user.

After finishing the above process, the report generation system displays the condition input interface customized by the user to the user. The user may enter the condition data in the condition input interface, and the report generation system generates the report according to the condition data. The detailed process of generating the report may be obtained with reference to the prior art, and is not repeated here.

FIG. 4 is a view of an implementation principle of the present invention. Referring to FIG. 4, condition data 1 corresponds to a graphical control 1 and a graphical control 1′. Similarly, the condition data 2 corresponds to a graphical control 2 and a graphical control 2′, but on processing, the condition data and the graphical controls are separated. The condition data includes the data, position, and other information entered by all the users of the component, and the graphical controls corresponding to the same group of the condition data may be exchanged according to the practical need. Recently, the user may select a Java Swing graphical control or an html graphical control, and different types of the condition input interfaces may be generated by using particular implementations of different graphical controls.

A generation apparatus for a report condition input interface according to an embodiment of the present invention includes an inquiry unit and an interface assembly unit.

The inquiry unit is configured to inquire a set corresponding relationship between condition data types and graphical controls according to a condition data type entered by a user, and obtain at least one graphical control corresponding to the condition data type.

The interface assembly unit is configured to assemble the graphical controls inquired by the inquiry unit and generate a condition input interface.

The apparatus further includes a relationship corresponding unit, configured to store the corresponding relationship between the condition data types and the graphical controls.

The apparatus further includes a previewing unit, configured to determine the number of label pages displaying the graphical controls and a display effect of each label page, according to the graphical controls inquired by the inquiry unit, and configured to display the display effect as a previewing result of the current condition input interface for the user.

The interface assembly unit is specifically configured to assemble the previewing result of the previewing unit and generate the condition input interface.

The apparatus further includes an adjusting unit, configured to adjust a display position and a display size of each graphical control according to a user instruction.

The apparatus further includes a non-condition data control unit, configured to store the graphical controls for entering and/or selecting report control information of non-condition data, and send the stored graphical controls to the interface assembly unit. The interface assembly unit is configured to assemble the graphical controls from the inquiry unit and the non-condition data control unit and generate the condition input interface.

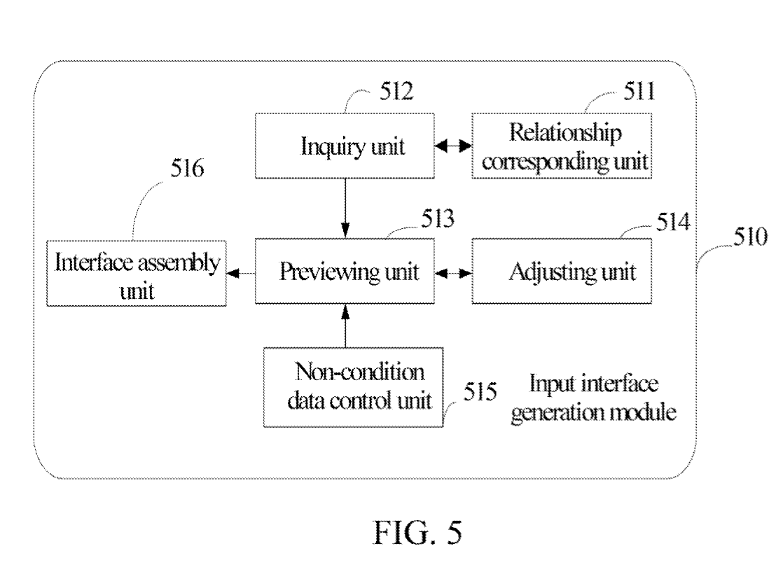

Referring to FIG. 5, the input interface generation module according to an embodiment of the present invention includes a relationship corresponding unit 511, an inquiry unit 512, a previewing unit 513, an adjusting unit 514, anon-condition data control unit 515, and an interface assembly unit 516.

The relationship corresponding unit 511 is configured to set up and store the corresponding relationship between the condition data types and the graphical controls. In an embodiment, the corresponding relationship may be the corresponding relationship list as shown in Table 1. During the practical application, the form and the content of the corresponding relationship list are not limited to Table 1.

The inquiry unit 512 is configured to inquire the relationship corresponding unit 511 according to the condition data type entered by the user, acquire the corresponding graphical control, and send the acquired graphical control to the previewing unit 513.

The non-condition data control unit 515 is configured to provide a function of controlling the report of the non-condition data for the user, that is, according to the user instruction, the report control data of the non-condition data is filled and/or selected, for example, the appearance of the report such as a color and a font is controlled, or, for example, a tabulator, a tabulating time, and other information are entered. The non-condition data control unit 515 stores the graphical controls enabling the user to enter and/or select the report control information of the non-condition data, and sends the stored graphical controls to the previewing unit 513.

The previewing unit 513 is configured to determine the number of the label pages displaying the graphical controls and the display effect of each label page, according to the graphical controls from the inquiry unit 5112 and the non-condition data control unit 515, and configured to display the display effect as the previewing result of the current condition input interface for the user.

The adjusting unit 514 is configured to receive the adjusting instruction entered by the user, and adjust the previewing result of the previewing unit 513, in which the adjusting unit 514 at least adjusts the display position and the display size of each displayed graphical control.

The interface assembly unit 516 is configured to assemble the current previewing result of the previewing unit 513 and generate the formal condition input interface.

Alternatively, the previewing unit 513 and/or the adjusting unit 514 may be omitted in the input interface generation module, the inquiry unit 512 and the non-condition data control unit 515 output the graphical controls to the interface assembly unit 516, and the interface assembly unit 516 assembles the graphical controls to generate the condition input interface.

It may be known from the above embodiment solution that in an embodiment of the present invention, for example, the drop list, the tree selection, and various complex controls may be provided in the report condition input interface for being used by the user, the usability of the report generation system is provided, the need of the user on a complex input condition is satisfied, and the form of the report may be adjusted according to the need of the user. Further, in an embodiment of the present invention, the operability and the feasibility of the report generation system are improved, so that the operator of the report may acknowledge the correctness of the report before the report is released, thereby improving the usability of the report generation system, and satisfying the need of the user of the report on a complex input condition. In addition, by entering the condition, the user of the report may further control the non-data base relevant characteristics of the final report, for example, the font, the color, and other appearance characteristics, so as to further enhance the functions of the report generation system.

Persons of ordinary skill in the art should understand that the steps in the same device in the method according to the embodiments of the present invention may be implemented by a program instructing relevant hardware. The program may be stored in a computer readable storage medium. When the program is run, the steps of the method according to the embodiment of the present invention are performed. The storage medium may be a ROM/RAM, a magnetic disk, an optical disk, and the like.

The above descriptions are merely several exemplary embodiments of the present invention, but not intended to limit the present invention. Any modification, equivalent replacement, and improvement made without departing from the spirit and principle of the present invention shall fall within the protection scope of the present invention.

What is claimed is:

1. A method for generating a condition input report interface, comprising:
inquiring a corresponding relationship list between condition data types. and graphical controls according to a condition data type entered by the user, and determining at least one graphical control corresponding to the condition data type; and
generating a condition input interface by assembling the at least one determined graphical control.

2. The method according to claim 1, wherein the process of generating a condition input interface by assembling the at least one determined graphical control comprises:
analyzing each selected graphical control, and determining the numbers of label pages to display the selected graphical according to the attribute of each graphical control;
determining display effect of each label page;
for each graphical control with the determined display effect, inquiring a corresponding result value from the database according to the condition data entered by the user, and filling the inquired result value into the graphical control for being selected and/or filled by the user; and
generating the condition input interface after receiving acknowledge information from the user.

3. The method according to claim 1, wherein the method further comprises:
setting a corresponding relationship list between condition data types and graphical controls, wherein each condition data type corresponds to at least one graphical control.

4. The method according to claim 2, wherein the process of determining display effect of each label page comprises at least one step from:
determining a display size and a display position of each graphical control;
determine the size of a window by analyzing a maximum width and a maximum height for all the graphical controls on the window; and
reserving a margin according to a pre-configured ratio or a ratio set by the user.

5. The method according to claim 2, wherein before the process of generating the condition input interface after receiving acknowledge information from the user, the method further comprises:
displaying the current condition input interface to the user according to the content selected and/or filled by the user; and
adjusting the current condition input interface according to an adjusting instruction from the user.

6. The method according to claim 1, wherein the process of generating a condition input interface by assembling the at least one determined graphical control comprises:
generating the condition input interface by assembling the graphical control configured to enter and/or select report control information of the non-condition data and the at least one determined graphical control.

7. The method according to claim 6, wherein the report control information of the non-condition data is at least one selected from front of the report, color of the report, a tabulator, and a tabulating time.

8. An apparatus for generating a condition input report interface, wherein the apparatus comprises:
an inquiry unit, configured to inquire a set corresponding relationship between condition data types and graphical controls according to a condition data type entered by a user, and obtain at least one graphical control corresponding to the condition data type; and
an interface assembly unit, configured to assemble the graphical controls inquired by the inquiry unit and generate a condition input interface.

9. The apparatus according to claim 8, wherein the apparatus further comprises:
a relationship corresponding unit, configured to store the corresponding relationship between the condition data types and the graphical controls.

10. The apparatus according to claim 9, wherein the apparatus further comprises:
a previewing unit, configured to determine the number of label pages displaying the graphical controls and a display effect of each label page, according to the graphical controls inquired by the inquiry unit, and display the display effect as a previewing result of the current condition input interface for the user;
the interface assembly unit, further configured to assemble the previewing result of the previewing unit and generate the condition input interface.

11. The apparatus according to claim 10, wherein the apparatus further comprises:
an adjusting unit, configured to adjust a display position and a display size of each graphical control according to a user instruction.

12. The apparatus according to claim 8, wherein the apparatus further comprises:
a non-condition data control unit, configured to store the graphical controls for entering and/or selecting report control information of non-condition data, and send the stored graphical controls to the interface assembly unit; and
the interface assembly unit is further configured to assemble the graphical controls from the inquiry unit and the non-condition data control unit and generate the condition input interface.

13. A method for generating a report, comprising:
inquiring a corresponding relationship list between condition data types and graphical controls according to a condition data type entered by the user, and determining at least one graphical control corresponding to the condition data type;
generating a condition input interface by assembling the at least one determined graphical control;
displaying the condition input interface to the user;
receiving the condition data entered by the user into the condition input interface; and
generating a report according to the condition data.

14. The method according to claim 13, wherein the process of generating a condition input interface by assembling the at least one determined graphical control comprises:
analyzing each selected graphical control, and determining the numbers of label pages to display the selected graphical according to the attribute of each graphical control;
determining display effect of each label page;
for each graphical control with the determined display effect, inquiring a corresponding result value from the database according to the condition data entered by the user, and filling the inquired result value into the graphical control for being selected and/or filled by the user; and
generating the condition input interface after receiving acknowledge information from the user.

15. The method according to claim 14, wherein the process of determining display effect of each label page comprises at least one step from:
determining a display size and a display position of each graphical control;
determine the size of a window by analyzing a maximum width and a maximum height for all the graphical controls on the window; and
reserving a margin according to a pre-configured ratio or a ratio set by the user.

16. The method according to claim 13, wherein the process of generating a condition input interface by assembling the at least one determined graphical control comprises:
generating the condition input interface by assembling the graphical control configured to enter and/or select report control information of the non-condition data and the at least one determined graphical control.
